(19) United States
(12) Patent Application Publication
(10) Pub. No.: US 2007/0022964 A1
(43) Pub. Date: Feb. 1, 2007

(54) System and method for cooling water within a pet bowl

(76) Inventors: Thomas K. Reusche, Elburn, IL (US); Philip E. Chumbley, Aurora, IL (US); James McHugh, Downers Grove, IL (US)

Correspondence Address: MCANDREWS HELD & MALLOY, LTD, 500 WEST MADISON STREET, SUITE 3400, CHICAGO, IL, 60661, US

(21) Appl. No.: 11/492,666

(22) Filed: Jul. 25, 2006

Related U.S. Application Data
(60) Provisional application No. 60/702,306, filed on Jul. 25, 2005.

(51) Int. Cl. A01K 7/00

(52) U.S. Cl. 119/73

(57) ABSTRACT

A system for cooling water within a pet bowl includes a porous container defining a water retaining cavity therein, wherein water within the water retaining cavity passes through the porous container and wicks to an outer surface of the porous container. The portion of the water that wicks to the outer surface evaporates, thereby cooling the water within said water retaining cavity.

### RELATED APPLICATIONS

This application relates to and claims priority benefits from U.S. Provisional Patent Application No. 60/702,306 entitled “Cooling Pet Bowl,” filed Jul. 25, 2005, which is hereby incorporated by reference in its entirety.

### FIELD OF THE INVENTION

Embodiments of the present invention generally relate to a pet bowl, and more particularly to a self-cooling pet bowl.

### BACKGROUND OF THE INVENTION

A conventional pet bowl retains water within a basin or interior cavity. As time passes, the retained water warms to room temperature. Often, water within the pet bowl remains in the bowl for hours. As such, the water within the pet bowl may become less appealing to a pet as time passes. That is, the pet, such as a family dog, may not choose to drink warm or hot water. Thus, on days when the pet should drink more water, the temperature of the drinking water may discourage the pet from doing so.

Thus, a need exists for a pet bowl that retains water at a cool temperature.

### SUMMARY OF THE INVENTION

Certain embodiments of the present invention provide a system for cooling water within a pet bowl. The system includes a porous, or water semi-permeable container defining a water retaining cavity therein, wherein water within the water retaining cavity passes through the porous container and wicks to an outer surface of the porous container. The portion of the water that wicks to the outer surface evaporates, thereby cooling the water within the water retaining cavity.

The system may also include a base supporting the porous container. Vents may be formed through the base such that the vents provide air passages in fluid communication with the porous container.

The system may also include a fan operable to circulate air around the outer surface of the porous container. Further, the porous container may be fluted, corrugated, and/or folded in order to provide greater surface area for evaporation.

The system may also include a non-porous bowl within the porous container. The non-porous bowl may be separated from the porous container by a cavity, wherein a liquid is retained within the cavity.

The system may also include an automatic liquid filling sub-system configured to automatically fill and maintain water within the porous container. The automatic liquid filling sub-system may include a float valve and water reservoir.

Certain embodiments of the present invention provide a system for cooling water within a pet bowl, including a porous, or water semi-permeable container defining a water retaining cavity therein. The porous container is configured to allow a portion of water within the water retaining cavity to diffuse through the porous container in order to cool the water within the water retaining cavity through evaporation.

### BRIEF DESCRIPTION OF SEVERAL VIEWS OF THE DRAWINGS

FIG. 1 illustrates a pet bowl system according to an embodiment of the present invention.

FIG. 2 illustrates a pet bowl system according to an embodiment of the present invention.

FIG. 3 illustrates a pet bowl system according to an embodiment of the present invention.

FIG. 4 illustrates a pet bowl system according to an embodiment of the present invention.

FIG. 5 illustrates a pet bowl system according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

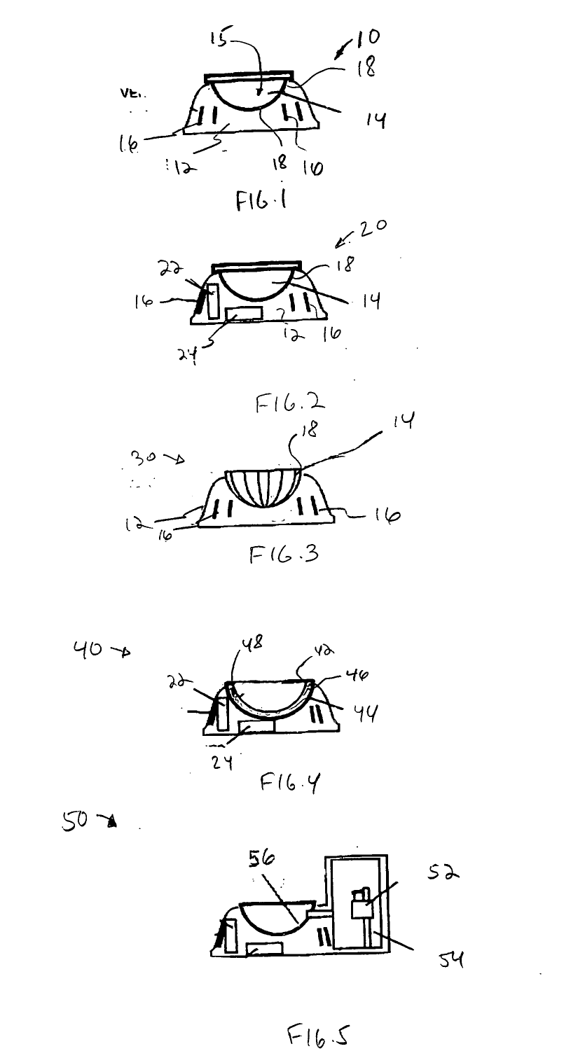

FIG. 1 illustrates a pet bowl system 10 according to an embodiment of the present invention. The pet bowl system 10 includes a base 12, which may be a generally cylindrical structure, supporting a water semi-permeable, porous basin or container 14. Water (not shown) may be retained within the porous container 14.

The base 12 includes vents 16 formed therethrough, which provide air passages to the porous container 14. Thus, air may pass through the base 12 and encounter the porous container 14 through the vents 16.

Evaporating water has a cooling effect. As water evaporates from the surface of an object, the temperature at the surface decreases due to the amount of energy required for a gram of water to make a phase transition between liquid and gas states.

The amount of heat required to raise the temperature of 1 gram of water by 1 degree Celsius is 1 calorie (4.184 Joules). However, the amount of heat required to evaporate 1 gram of water is 540 calories. Thus, in a bowl containing 541 grams of water, one gram of water evaporating draws 540 calories of heat from the remaining water and lowers the temperature of the remaining water by 1 degree Celsius.

The porosity of the porous container 14 is such that the water passes from an interior retaining cavity 15, through an outer surface 18, and wicks to the outer surface 18, but does not drip from the outer surface 18. That is, water within the retaining cavity 15 diffuses through the outer surface 18, and evaporates from the outer surface 18 of the container 14, thereby providing an evaporative cooling effect. Allowing water to soak through the porous container 14 to the outer surface 18 (including the outer surface of the base) greatly increases the surface area from which water can evaporate and provide cooling. That is, because the container 14 is porous, water can pass through the porous container 14, thereby providing paths for evaporation in addition to the surface of the water contained within the porous container 14. Passive cooling from the outer surface lowers the temperature of the water within the porous container more so than surface evaporation alone.

The base 12 provides a mechanical support structure for the porous container. The vents 16 allow air to pass through the base 12 and contact water on the outer surface 18 of the porous container 14, thereby accelerating evaporation.

FIG. 2 illustrates a pet bowl system 20 according to an embodiment of the present invention. The pet bowl system 20 includes the porous container 14 having an outer surface 18, and a support base 12 having a plurality of vents 16, as discussed above with respect to FIG. 1. Additionally, the pet bowl system 20 includes a fan 22 that can be AC or battery powered. For example, the fan 22 may be electrically connected to a source of power, such as a battery 24. The fan 22 may be activated to cool the water within the porous container 18 even further. That is, the fan 22 may blow air over the outer surface 18 of the porous container 14 to promote quicker evaporation.

FIG. 3 illustrates a pet bowl system 30 according to an embodiment of the present invention. The pet bowl system 30 is similar to the pet bowls 10 and 20 discussed above, except that the pet bowl 14 may have a fluted, corrugated, folded, or other such outer surface 18 that has an increased surface area for evaporation.

FIG. 4 illustrates a pet bowl system 40 according to an embodiment of the present invention. The pet bowl system 40 includes a non-porous container 42 suspended within a porous container 44. Water 46 is retained within a cavity 48 defined between the porous container 44 and the non-porous container 42. A water inlet (not shown) may be formed through a portion of the porous container (such as proximate a top edge) to allow one to pour water into the cavity 48. The system 40 may also include the fan 22, and the power source 24 discussed above. Further, the porous container 44 may be fluted, corrugated, folded, or the like. Heat is lost by evaporation through the porous container 44. The water 46 (or other liquid) within the cavity 48 serves as a heat path to draw heat from the interior non-porous container 42.

FIG. 5 illustrates a pet bowl system 50 according to an embodiment of the present invention. The system 50 includes a float valve 52 and water reservoir 54 operable to add more water to the container 56 (such as a porous container), as needed. The float valve 52 and water reservoir 54 act to automatically fill the container 56, as described in U.S. application Ser. No. 11/269,063, entitled “System and Method for Automatically Filling a Liquid Receptacle,” filed Nov. 8, 2005, which is hereby incorporated by reference in its entirety.

Thus, embodiments of the present invention provide a self-cooling pet bowl that retains water at a cool temperature.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A system for cooling water within a pet bowl, comprising:
a porous container defining a water retaining cavity therein, wherein water within said water retaining cavity passes through said porous container and wicks to an outer surface of said porous container, wherein the portion of the water that wicks to said outer surface evaporates, thereby cooling the water within said water retaining cavity.

2. The system of claim 1, further comprising a base supporting said porous container.

3. The system of claim 2, wherein said base comprises vents in fluid communication with said porous container.

4. The system of claim 1, further comprising a fan operable to circulate air around said outer surface.

5. The system of claim 1, wherein said porous container is at least one of fluted, corrugated, and folded.

6. The system of claim 1, further comprising a non-porous bowl within said porous container, said non-porous bowl separated from said porous container by a cavity, wherein a liquid is retained within said cavity.

7. The system of claim 1, further comprising an automatic liquid filling sub-system configured to automatically fill and maintain water within said porous container.

8. The system of claim 7, wherein said automatic liquid filling sub-system comprises a float valve and water reservoir.

9. A pet bowl cooling system comprising:
a water semi-permeable container defining a water retaining cavity therein, wherein a portion of the water within said water retaining cavity passes through said water semi-permeable container and wicks to an outer surface of said water semi-permeable container, wherein the portion of the water that wicks to said outer surface evaporates, thereby cooling the water within said water retaining cavity; and
a base supporting said water semi-permeable container, said base comprising vents in fluid communication with said water semi-permeable container.

10. The system of claim 9, further comprising a fan operable to circulate air around said outer surface.

11. The system of claim 9, wherein said water semi-permeable container is at least one of fluted, corrugated, and folded.

12. The system of claim 9, further comprising a non-porous bowl within said semi-permeable container, said non-porous bowl separated from said semi-permeable container by a cavity, wherein a liquid is retained within said cavity.

13. The system of claim 9, further comprising an automatic liquid filling sub-system configured to automatically fill and maintain water within said semi-permeable container.

14. The system of claim 13, wherein said automatic liquid filling sub-system comprises a float valve and water reservoir.

15. A system for cooling water within a pet bowl, comprising:
a porous container defining a water retaining cavity therein, wherein said porous container is configured to allow a portion of water within said water retaining cavity to diffuse through said porous container in order to cool the water within said water retaining cavity through evaporation.

16. The system of claim 15, further comprising a base supporting said porous container, said base comprising vents in fluid communication with said porous container.

17. The system of claim 15, further comprising a fan operable to circulate air around said porous container.

18. The system of claim 15, wherein said porous container is at least one of fluted, corrugated, and folded.

19. The system of claim 15, further comprising a non-porous bowl within said porous container, said non-porous bowl separated from said porous container by a cavity, wherein a liquid is retained within said cavity.

20. The system of claim 15, further comprising an automatic liquid filling sub-system configured to automatically fill and maintain water within said porous container, said automatic liquid filling sub-system comprising a float valve and water reservoir.
